(19) United States
(12) Patent Application Publication
(10) Pub. No.: US 2010/0308595 A1
(43) Pub. Date: Dec. 9, 2010

(54) WIND-POWER GENERATING DEVICE WITH AUTOMATIC ADJUSTMENT TO WIND DIRECTION

(75) Inventor: Shih H. CHEN, Yongkang City (TW)

Correspondence Address: HDLS IPR Services, PO Box 220746, Chantilly, VA, 20153, US

(73) Assignee: Jetpro Technology, Inc.

(21) Appl. No.: 12/729,068

(22) Filed: Mar. 22, 2010

(30) Foreign Application Priority Data
Jun. 9, 2009 (TW) 098210202

(51) Int. Cl. F03D 1/04; F03D 9/00

(52) U.S. Cl. 290/55

(57) ABSTRACT

A wind-power generating device (1) with automatic adjustment to wind direction includes a post (10), a wind-guiding shroud (20), and a generator assembly (30). The post (10) has a fixed section (11) and a rotatable section (12) pivotally connected to an upper portion of the fixed section (11). The wind-guiding shroud (20) is fixed to the rotatable section (12). The interior of the wind-guiding shroud (20) is formed with an accommodating space (211), and the exterior thereof is formed with an outer curved surface (212) expanding gradually toward its rearward. The generator assembly (30) is fixed in the accommodating space (211). The outer curved surface (212) is blown by the wind, so that the wind-guiding shroud (20) can rotate with automatic adjustment to the wind direction by the rotatable section (12).

### BACKGROUND OF THE INVENTION

1. Field of the Invention

The present invention relates to a wind-power generating device, and in particular to a wind-power generating device with automatic adjustment to wind direction.

2. Description of Prior Art

With the rise of the concept of environmental protection, more attention has been paid to the technologies of generating electricity from natural resources. Thus, many countries aim to develop the technologies of generating electricity from the wind power.

Conventionally, a wind-power generating device includes a main body, a wind turbine, a post and a generator. The post is usually fixed on the ground, but it is not limited thereto. The post may be fixed to a roof of a house or a car. The top of the post is connected to the bottom of the main body. The generator is usually received inside the main body and provided with a spindle. The wind turbine is located in front of the main body and pivotally connected to the spindle. When the wind turbine is blown by wind to rotate, the rotation of the wind turbine drives the spindle to rotate accordingly, whereby the generator can generate electricity. This device further includes a power storage means such as a battery for storing the electricity generated by the generator.

Since the wind direction is changeable, the main body has to be pivotally connected to the post to make the main body to be rotatable with respect to the post. The rear of the main body has to be connected to a rudder. With this arrangement, the wind-power generating device can continuously generate electricity with automatic adjustment to wind direction.

However, in practice, the conventional wind-power generating device still has some drawbacks. The rudder located in back of the main body is usually connected to the main body by welding, which requires more material cost and production cost. Further, the structural strength of the welded portion between the rudder and the main body is insufficient.

Therefore, the present Inventor devotes himself to solve the above-mentioned problem.

### SUMMARY OF THE INVENTION

The present invention is to provide a wind-power generating device with automatic adjustment to wind direction. With an outer curved surface being blown by wind, a wind-guiding shroud can rotate with automatic adjustment to the wind direction by the rotatable section. With this arrangement, the wind-power generating device can be automatically adjusted to the wind direction without consuming electricity in rotating the wind-power generating device, thereby increasing the power-generating efficiency of the wind-power generating device.

The present invention is to provide a wind-power generating device with automatic adjustment to wind direction, which includes a post, a wind-guiding shroud, and a generator assembly. The post has a fixed section and a rotatable section pivotally connected an upper portion of the fixed section. The wind-guiding shroud is fixed to the rotatable section. The interior of the wind-guiding shroud is formed with an accommodating space, and the exterior thereof is formed with an outer curved surface gradually expanding toward its rearward. The generator assembly is fixed in the accommodating space. The outer curved surface is blown by wind, so that the wind-guiding shroud can rotate with automatic adjustment to the wind direction by the rotatable section.

The present invention is to provide a wind-power generating device with automatic adjustment to wind direction, which includes a post, a wind-guiding shroud, and a generator assembly. The post has a fixed section and a rotatable section pivotally connected an upper portion of the fixed section. The wind-guiding shroud is fixed to the rotatable section. The interior of the wind-guiding shroud is formed with an accommodating space, and the exterior thereof is formed with an inclined surface gradually expanding toward its rearward. The generator assembly is fixed in the accommodating space. The inclined surface is blown by wind, so that the wind-guiding shroud can rotate with automatic adjustment to the wind direction by the rotatable section.

In comparison with prior art, the outer curved surface of the wind-guiding shroud and the eccentric arrangement of the wind-guiding shroud with respect to the post allow the wind-power generating device of the present invention for automatic adjustment to wind direction without consuming electricity in rotating the wind-power generating device. Since the wind-power generating device having the wind-guiding shroud is configured with automatic adjustment to wind direction, it is unnecessary to mount a rudder on this device, thereby reducing material cost and production process. Further, the inner curved surface of the wind-guiding shroud is configured to have a converged front end and a diverged rear end, so that the wind blowing into the wind-guiding shroud can be accelerated to increase the power-generating efficiency of the generator. The wind-guiding shroud is constituted of a plurality of wind-guiding pieces, which facilitates the maintenance and assembly of the wind-guiding shroud.

### BRIEF DESCRIPTION OF THE DRAWINGS

FIG. 1 is an exploded perspective view showing a wind-guiding shroud and a post of the present invention;

FIG. 2 is an exploded perspective view of the present invention;

FIG. 3 is a perspective view showing the external appearance of the present invention;

FIG. 4 is an exploded perspective view showing another embodiment of the present invention;

FIG. 5 is a perspective view showing the external appearance of another embodiment of the present invention;

FIG. 6 is a side view showing another embodiment of the present invention;

FIG. 7 is a side view showing the operating state of another embodiment of the present invention; and

FIG. 8 is a top view showing the operating state of another embodiment of the present invention.

### DETAILED DESCRIPTION OF THE INVENTION

The detailed description and technical contents of the present invention will be described in more detail with reference to preferred embodiments thereof shown in the accompanying drawings. However, it should be understood that the drawings are illustrative only, but not used to limit the scope of the present invention.

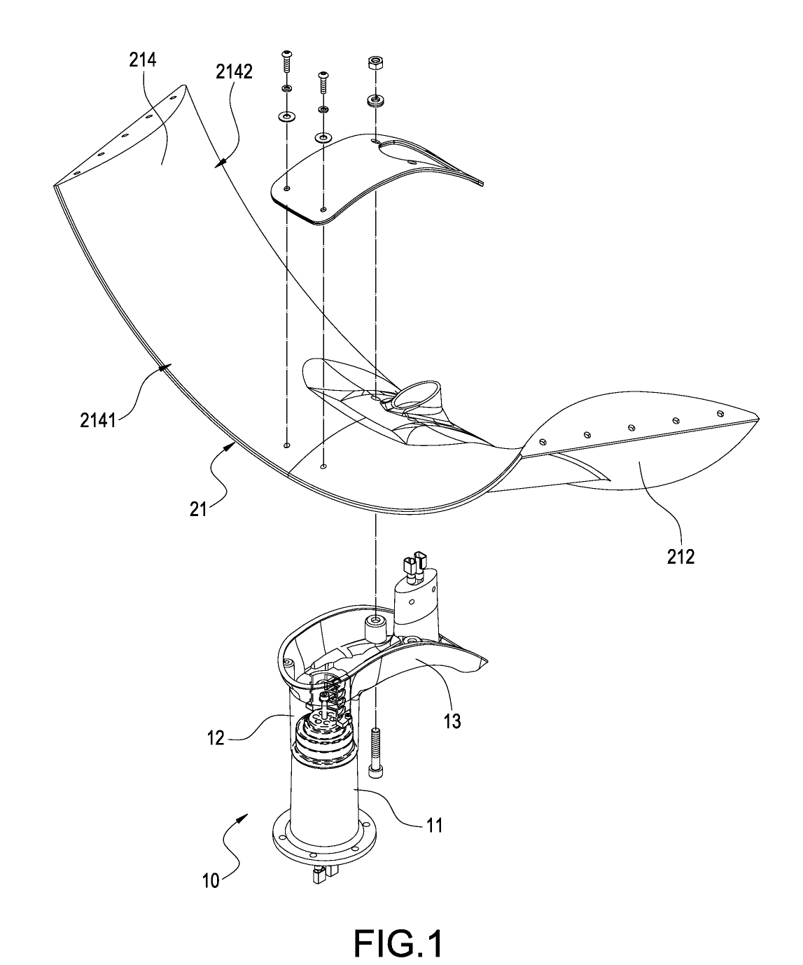

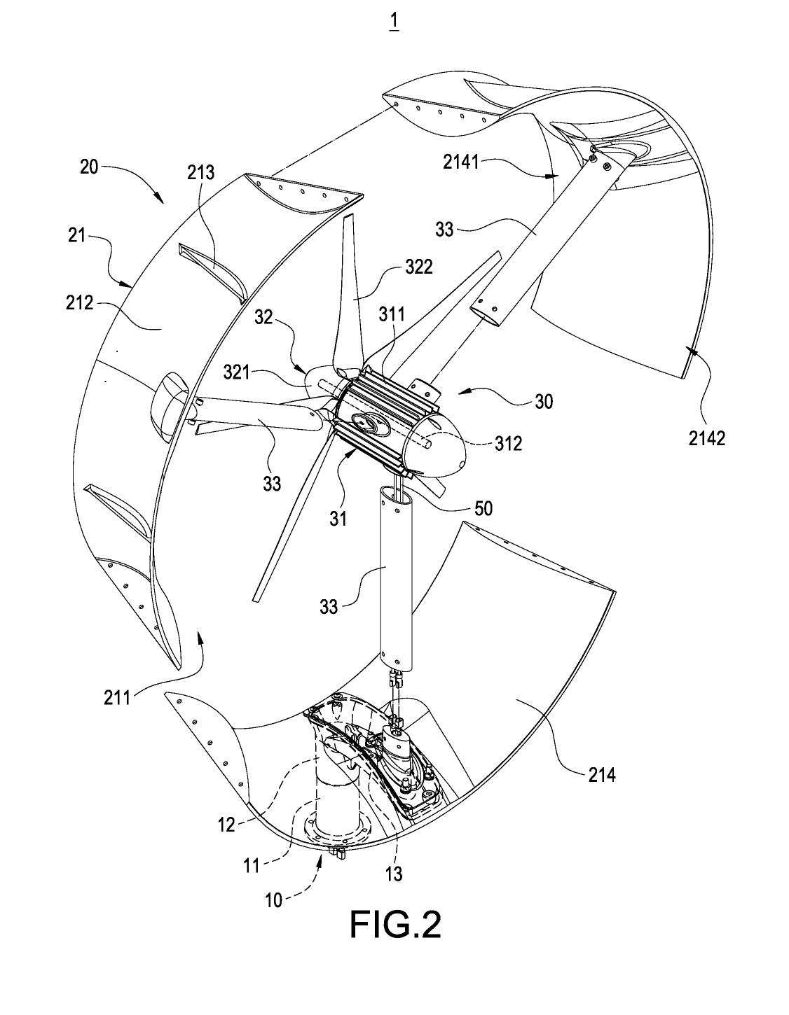

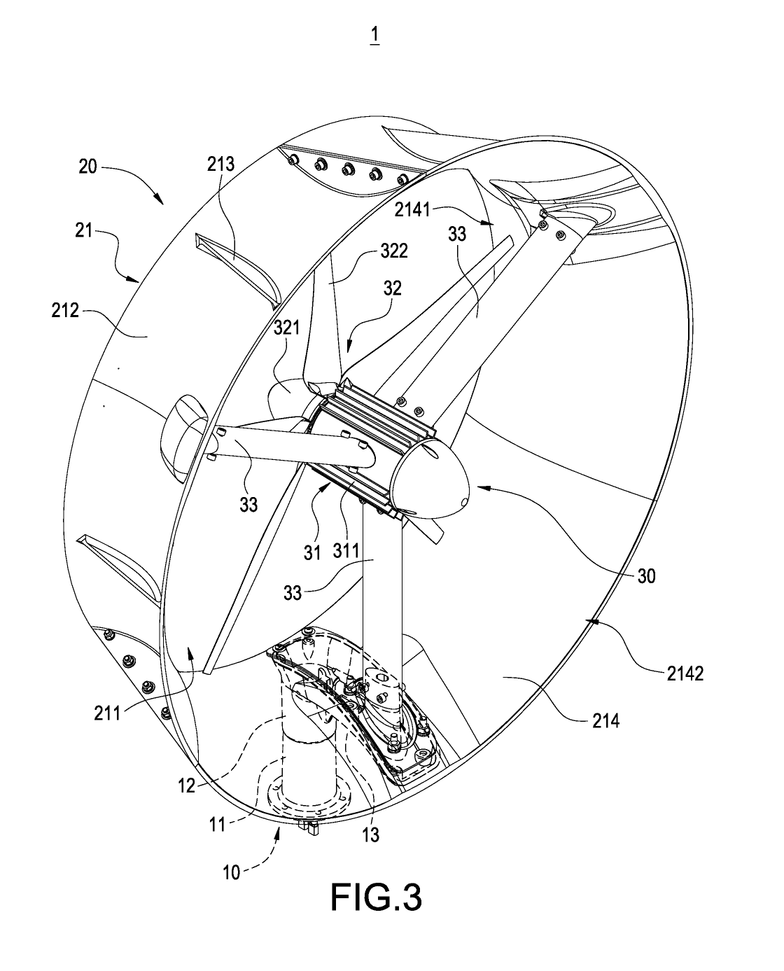

Please refer to FIGS. 1 to 3. FIG. 1 is an exploded perspective view showing a wind-guiding shroud and a post of the present invention. FIG. 2 is an exploded perspective view of the present invention. FIG. 3 is a perspective view showing the external appearance of the present invention. The present invention provides a wind-power generating device 1 with automatic adjustment to wind direction, which includes a post 10, a wind-guiding shroud 20, a generator assembly 30 and a wind turbine 32.

The post 10 has a fixed section 11, a rotatable section 12 pivotally connected to an upper portion of the fixed section 11, and a supporting arm 13 connected to the rotatable section 12. The supporting arm 13 is substantially perpendicular to the rotatable section 12. In the present embodiment, the top of the post 10 is substantially formed into an inverted “L” shape.

The wind-guiding shroud 20 is fixed to the rotatable section 12 and the supporting arm 13. The interior of the wind-guiding shroud 20 is formed with an accommodating space 211. The exterior of the wind-guiding shroud 20 is formed with an outer curved surface 212 gradually expanding toward its rearward. More specifically, the wind-guiding shroud 20 is constituted of a plurality of wind-guiding pieces 21. In the present embodiment, the number of the wind-guiding pieces 21 is three, but it is not limited thereto. Further, the outer curved surface 212 may be replaced by an inclined surface gradually expanding toward its rearward.

The interior of the wind-guiding shroud 21 is formed with an inner curved surface 214. The front end of the inner curved surface 214 is formed into a converged section 2141, while the rear end thereof is formed into a diverged section 2142 extending rearwards from the converged section 2141. Further, the outer wall of the wind-guiding piece 21 is fixed with a plurality of reinforcing ribs 213 for increasing the structural strength.

The generator assembly 30 is fixed in the accommodating space 211. The generator assembly 30 comprises a main body 31, a wind turbine 32 and a plurality of fixing rods 33. The outer surface of the main body 31 is provided with a plurality of heat-dissipating pieces 311. The front end of the main body 31 is pivotally connected to a spindle 312. The wind turbine 32 comprises a nose cover 321 fixed to the spindle 312 and a plurality of blades 322 connected to the nose cover 321. Each of the fixing rods 33 is a hollow rod with its both ends connected to the wind-guiding piece 21 and the main body 31 respectively, thereby fixing the main body 31 in the center of the accommodating space 211. The main body 31 is further electrically connected to a plurality of leads 50 for transmitting the electricity generated by the generator assembly 30. The leads 50 are connected to the bottom of the main body 31 and penetrate one fixing rod 33 to be connected with the supporting arm 13 of the post 10.

The outer curved surface 212 is blown by wind, so that the wind-guiding shroud 20 can rotate with automatic adjustment to the wind direction.

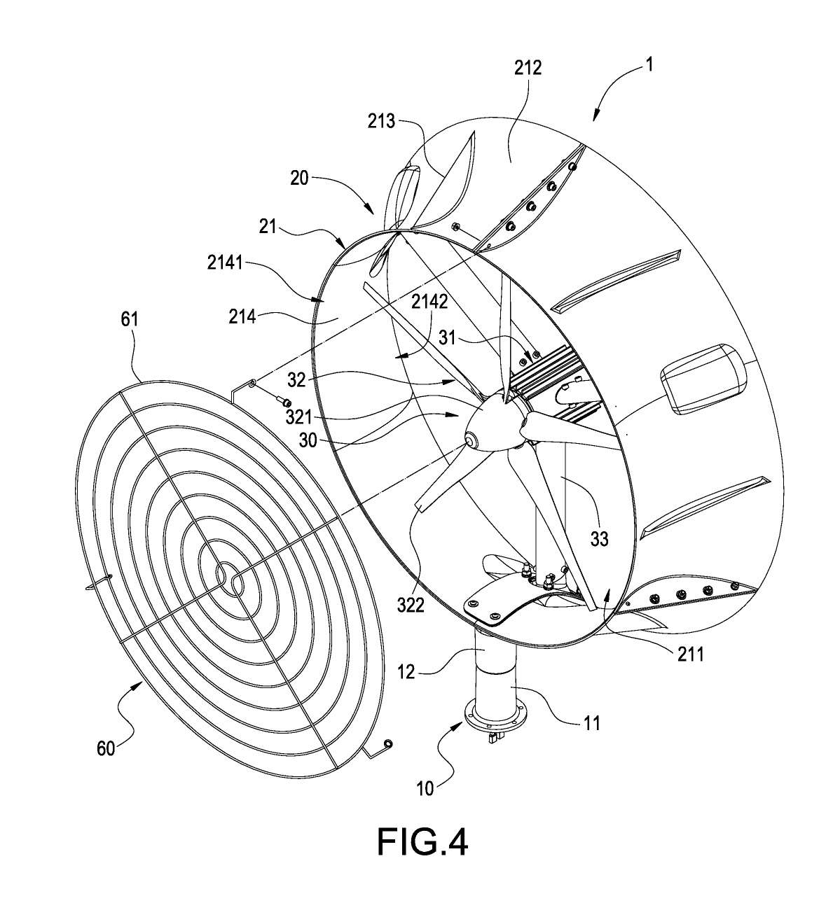

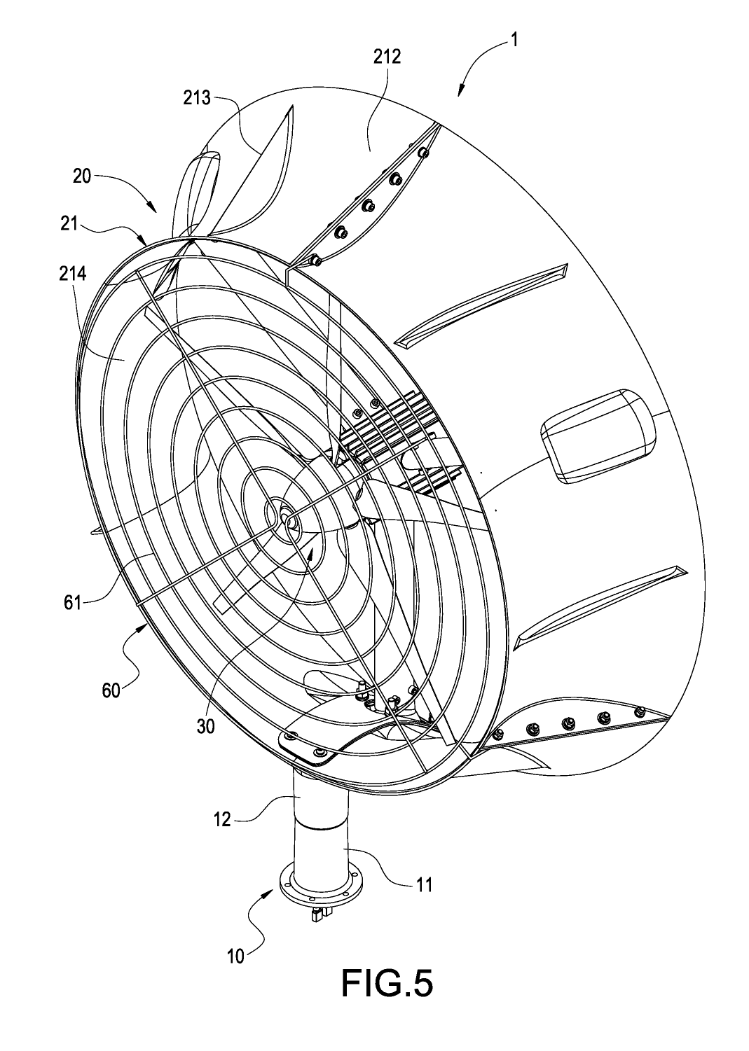

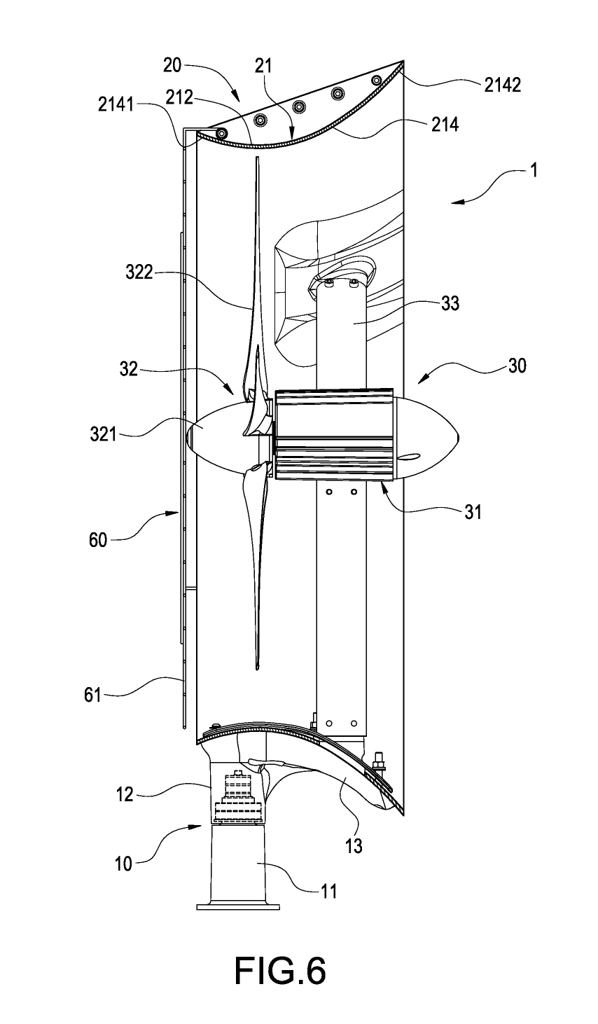

Please refer to FIGS. 4 to 6. FIG. 4 is an exploded perspective view showing another embodiment of the present invention. FIG. 5 is a perspective view showing the external appearance of another embodiment of the present invention. FIG. 6 is a side view showing another embodiment of the present invention. The wind-power generating device 1 further comprises a protection net 60 fixed in front of the wind-guiding shroud 20. The protection net 60 serves to protect foreign matters from entering the wind-guiding shroud 20 to make the generator 30 and the wind turbine 32 to suffer damage. On the other hand, the protection net 60 can protect birds from accidentally entering the wind-guiding shroud 20. The protection net 60 has a circular shape to correspond to the opening of the wind-guiding shroud 20. The protection net 60 is constituted of a plurality of wires 61 connected to one another. These wires comprise a plurality of concentric lines of different diameters and a plurality of straight lines connecting the circular lines, but they are not limited thereto.

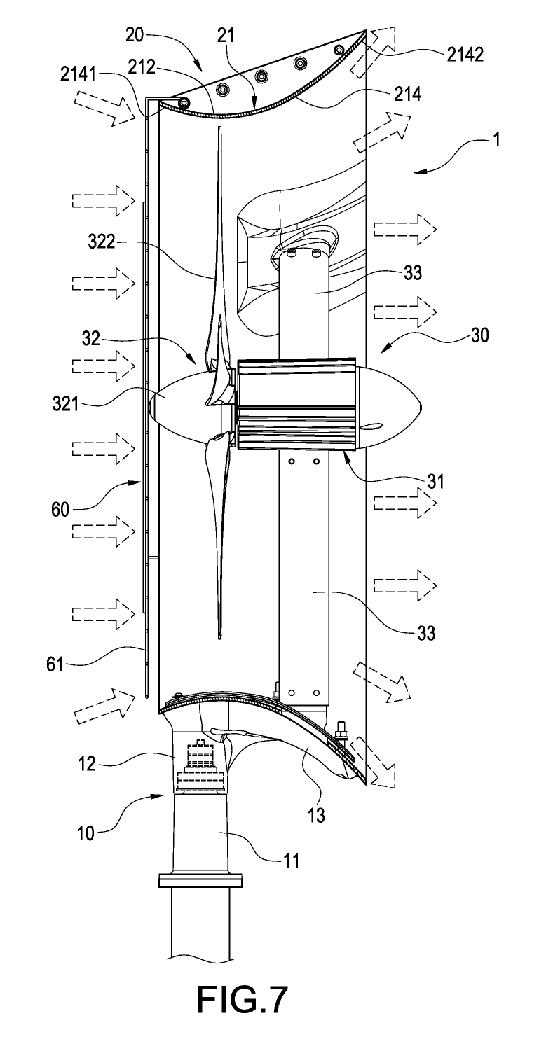

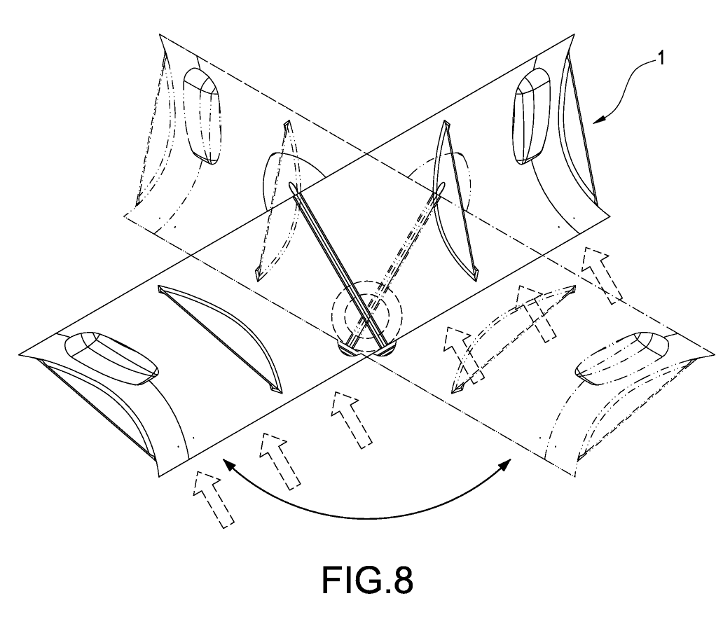

Please refer to FIGS. 7 and 8. FIG. 7 is a side view showing the operating state of another embodiment of the present invention. FIG. 8 is a top view showing the operating state of another embodiment of the present invention. The blade 322 serves as a divide for the inner curved surface 214. The inner curved surface 214 of the wind-guiding piece 21 in front of the blade 322 is formed into a converged section 2141, while the inner curved surface 214 of the wind-guiding piece 21 in back of the blade 322 is formed into a diverged section 2142. Such a profile can accelerate the wind flowing into the wind-guiding shroud 21 to increase the rotating speed of the generator assembly 30 and thus increase the electricity generated by the generator assembly 30. Further, the resultant center of gravity of the wind-guiding shroud 20 and the generator assembly 30 is located in rear of the axial line of the post 10. Such an eccentric design can significantly enhance the effect of the wind-guiding shroud 20 for automatic adjustment to the wind direction.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A wind-power generating device (1) with automatic adjustment to wind direction, including:
a post (10) having a fixed section (11) and a rotatable section (12) pivotally connected to an upper portion of the fixed section (11);
a wind-guiding shroud (20) fixed to the rotatable section (12), the interior of the wind-guiding shroud (20) being formed with an accommodating space (211), and the exterior thereof being formed with an outer curved surface (212) expanding gradually toward its rearward; and
a generator assembly (30) fixed in the accommodating space (211);
wherein the outer curved surface (212) is blown by the wind, so that the wind-guiding shroud (20) can rotate with automatic adjustment to the wind direction by the rotatable section (12).

2. The wind-power generating device (1) with automatic adjustment to wind direction according to claim 1, wherein the post (10) further comprises a supporting arm (13) connected to the rotatable section (12), the supporting arm (13) is connected to the wind-guiding shroud (20).

3. The wind-power generating device (1) with automatic adjustment to wind direction according to claim 2, wherein the wind-guiding shroud (20) is constituted of a plurality of wind-guiding pieces (21).

4. The wind-power generating device (1) with automatic adjustment to wind direction according to claim 3, wherein the generator assembly (30) comprises a plurality of blades (322), and the inner wall of the wind-guiding piece (21) is formed into a converged section (2141) in front of the blade (322) and a diverged section (2142) in back of the blade (322).

5. The wind-power generating device (1) with automatic adjustment to wind direction according to claim 3, wherein the generator assembly (30) comprises a main body (31) and a wind turbine (32) pivotally connected to the main body (31), and the wind turbine (32) is rotatable with respect to the main body (31).

6. The wind-power generating device (1) with automatic adjustment to wind direction according to claim 1, further including a protection net (60) fixed in front of the wind-guiding shroud (20).

7. The wind-power generating device (1) with automatic adjustment to wind direction according to claim 1, wherein the resultant center of gravity of the wind-guiding shroud (20) and the generator assembly (30) is located in back of an axial line of the post (10).

8. A wind-power generating device (1) with automatic adjustment to wind direction, including:
a post (10) having a fixed section (11) and a rotatable section (12) pivotally connected to an upper portion of the fixed section (11);
a wind-guiding shroud (20) fixed to the rotatable section (12), the interior of the wind-guiding shroud (20) being formed with an accommodating space (211), and the exterior thereof being formed with an inclined surface (212) expanding gradually toward its rearward; and
a generator assembly (30) fixed in the accommodating space (211);
wherein the inclined surface (212) is blown by the wind, so that the wind-guiding shroud (20) can rotate with automatic adjustment to the wind direction by the rotatable section (12).

9. The wind-power generating device (1) with automatic adjustment to wind direction according to claim 8, wherein the post (10) further comprises a supporting arm (13) connected to the rotatable section (12), the supporting arm (13) is connected to the wind-guiding shroud (20).

10. The wind-power generating device (1) with automatic adjustment to wind direction according to claim 9, wherein the wind-guiding shroud (20) is constituted of a plurality of wind-guiding pieces (21).

11. The wind-power generating device (1) with automatic adjustment to wind direction according to claim 10, wherein the generator assembly (30) comprises a plurality of blades (322), and the inner wall of the wind-guiding piece (21) is formed into a converged section (2141) in front of the blade (322) and a diverged section (2142) in back of the blade (322).

12. The wind-power generating device (1) with automatic adjustment to wind direction according to claim 10, wherein the generator assembly (30) comprises a main body (31) and a wind turbine (32) pivotally connected to the main body (31), and the wind turbine (32) is rotatable with respect to the main body (31).

13. The wind-power generating device (1) with automatic adjustment to wind direction according to claim 8, further including a protection net (60) fixed in front of the wind-guiding shroud (20).

14. The wind-power generating device (1) with automatic adjustment to wind direction according to claim 8, wherein the resultant center of gravity of the wind-guiding shroud (20) and the generator assembly (30) is located in back of an axial line of the post (10).
